(19) United States
(12) Patent Application Publication
(10) Pub. No.: US 2018/0292131 A1
(43) Pub. Date: Oct. 11, 2018

(54) Garment Drying Device

(71) Applicants: Gilbert Juarez, San Diego, CA (US); Paul Michael McCaffrey, San Diego, CA (US)

(72) Inventors: Gilbert Juarez, San Diego, CA (US); Paul Michael McCaffrey, San Diego, CA (US)

(21) Appl. No.: 15/481,603

(22) Filed: Apr. 7, 2017

(51) Int. Cl. F26B 21/00; F26B 3/04; F26B 9/00

(52) U.S. Cl. CPC F26B 21/008; F26B 9/003; F26B 3/04

(57) ABSTRACT

A device for drying the liners of prosthetic devices. The drying device includes a pair of panels each having a head and a base. A plurality of protrusions extends from each of the heads about a first mid-line. The first panel and the second panel interlock perpendicularly with each other at the first and second mid-lines to create a free-standing device in an X shape.

### BACKGROUND OF THE INVENTION

The present invention relates to racks for drying garments. More specifically, the present invention provides a drying device adapted to dry the gel liners of prosthetic devices.

Many people use prosthetic devices with gel liners. It is important to regularly clean a prosthetic gel liner, as over time it accumulates bacteria and dead skin from use. Failing to clean a gel liner can lead to an increased risk of infection due to the unsanitary conditions. While it is important to clean the gel liner, it is also important to handle it carefully as any mishandling could result in the liner hardening or stretching. After cleaning, it must be fully dried before being used again. Therefore, a device that can dry the gel liners without causing persistent damage is provided.

In light of the devices disclosed in the known art, it is submitted that the present invention substantially diverges in design elements from the known art and consequently it is clear that there is a need in the art for an improvement to existing garment drying devices. In this regard, the instant invention substantially fulfills these needs.

### SUMMARY OF THE INVENTION

In view of the foregoing disadvantages inherent in the known types of drying devices now present in the prior art, the present invention provides a drying device wherein the same can be utilized for providing convenience for the user when drying a garment such as the gel lining of a prosthetic device.

The present system comprises a first panel having a first head and a first base and a second panel having a second head and a second base. The first and second heads include a first and second plurality of protrusions, respectively. The first and second panels are configured to interlock perpendicularly with each other along a first and second mid-line of the first and second panels, respectively. In some embodiments, a first slot extends downward from the first head of the first panel at the first mid-line, and a second slot extends upward from the second base of the second panel at the second mid-line. In some embodiments, a first and second cutout are disposed along the first and second bases respectively and are configured to fit a fan within. In other embodiments, the drying device further comprises a fastener to removably secure the gel liner to the drying device.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the drying device.

FIG. 2 shows an exploded view of an alternative embodiment of the drying device.

FIG. 3 shows a perspective view of an embodiment of the cylindrical cap of the drying device being attached to the first and the second head and a perspective view of an embodiment of the cylindrical cap of the drying device attached to the first and the second head.

FIG. 4 shows a perspective view of an embodiment of the drying device in use.

FIG. 5 shows a perspective view of an embodiment of the drying device in use.

FIG. 6 shows a perspective view of an alternate embodiment of the drying device.

FIG. 7 shows a perspective view of an alternate embodiment of the drying device.

### DETAILED DESCRIPTION OF THE INVENTION

Reference is made herein to the attached drawings. Like reference numerals are used throughout the drawings to depict like or similar elements of the drying device. The figures are intended for representative purposes only and should not be considered to be limiting in any respect.

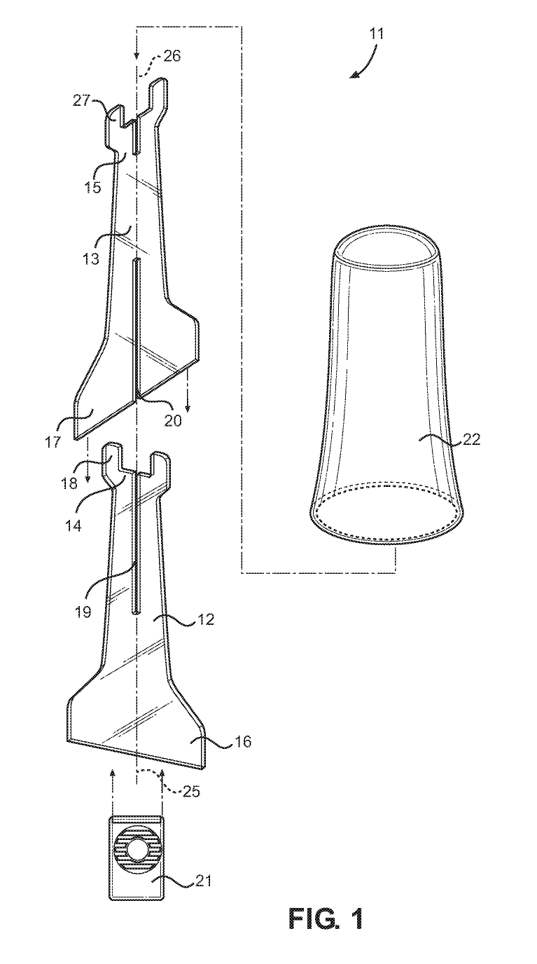

Referring now to FIG. 1, there is shown an exploded view of an embodiment of the drying device. A drying device 11 is comprised of a first panel 12 and a second panel 13. The first panel 12 comprises a first head 14 and a first base 16. The first head 14 includes a first plurality of protrusions 18 disposed equiangularly from a first mid-line 25. In some embodiments, the first plurality of protrusions 18 comprise a rounded shape. In yet other embodiments, the first plurality of protrusions 18 extend at various angles from the first mid-line 25. In the illustrated embodiment, the first panel 12 further includes a first slot 19 extending downwards from the first head 14 at the first mid-line 25.

The second panel 13 comprises a second head 15 and a second base 17. The second head 15 includes a second plurality of protrusions 27 disposed equiangularly from a second mid-line 26. In some embodiments, the second plurality of protrusions 27 comprise a rounded shape. In yet other embodiments, the second plurality of protrusions 27 extend at various angles from the second mid-line 26. In the illustrated embodiment, the second panel 13 further includes a second slot 20 extending upwards from the second base 17 at the second mid-line 26.

The first panel 12 and the second panel 13 are adapted to interlock perpendicularly creating an X shape when viewed from overhead. In the illustrated embodiment, the second panel 13 is aligned perpendicularly to the first panel 12 and lowered along the first and second mid-lines 25, 26. The first slot 19 engages with the second panel 13 and the second slot 20 engages with the first panel 12 forming the drying device 11. In the illustrated embodiment, a fan 21 is rested against the first and second panels 12, 13 at the first and second mid-lines 25, 26 such that the air circulated by the fan 21 extends upwards towards the first and second heads 14, 15. A liner 22 is draped over the first and second heads 14, 15 to rest on the first and second plurality of protrusions 18, 27. The air circulated by the fan 21 enters the liner 22 to create ventilation.

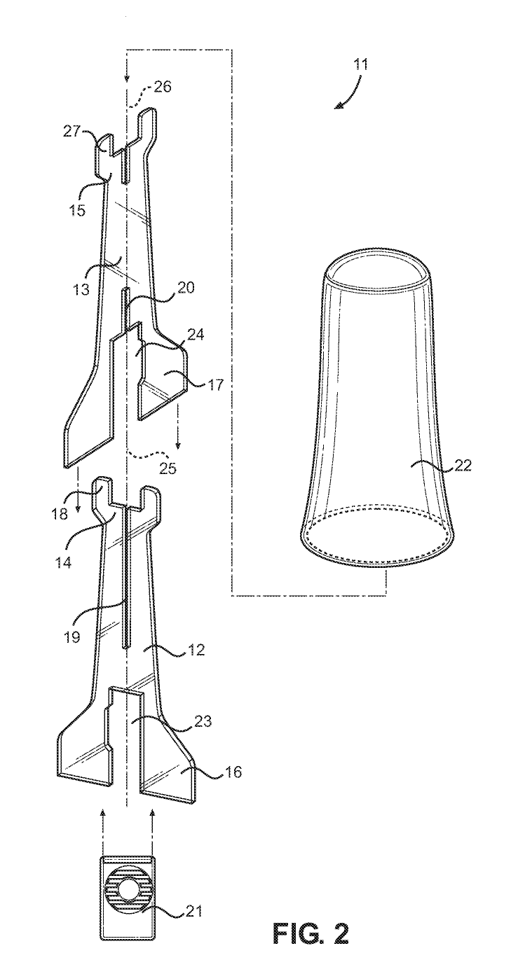

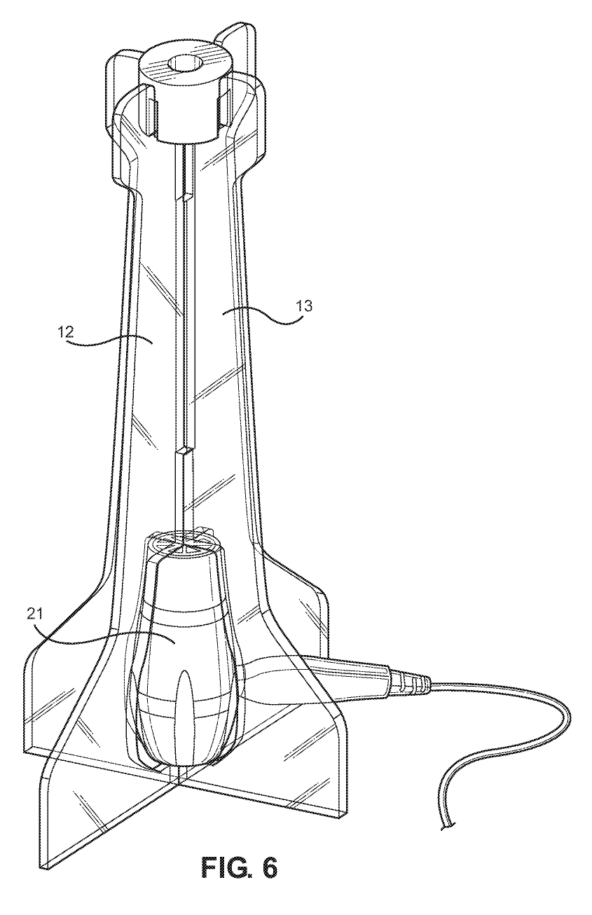

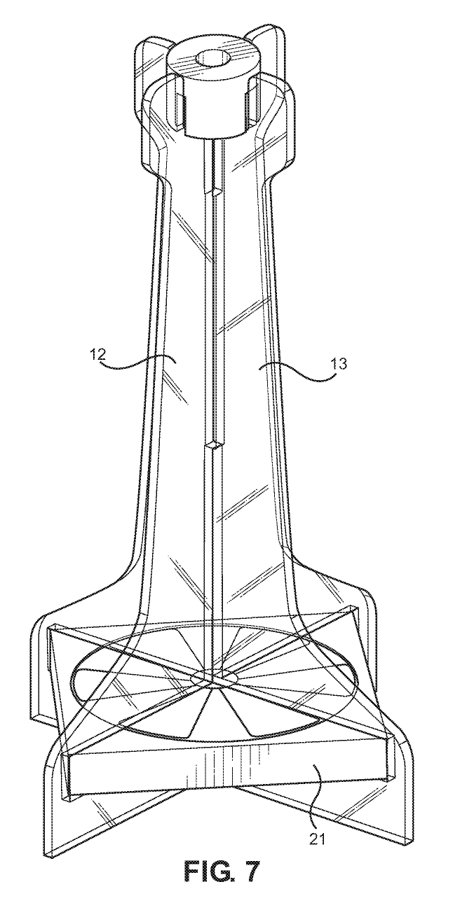

Referring now to FIGS. 2, 6, and 7, there is shown an exploded view of an alternative embodiment of the drying device, and perspective views of various alternate embodiments of the drying device, respectively. The first and second panels 12, 13 further include a first and second cutout 23, 24. The first and second cutouts 23, 24 are adapted to fit the fan 21. In the illustrated embodiment, when the first and second panels 12, 13 are engaged with each other, the fan 21 fits within the first and second cutouts 23, 24, such that it is supported by the first and second panels 12, 13. In the illustrated embodiment of FIG. 2, the fan 21 comprises a vertical fan resting parallel to the first and second panels 12, 13. In the embodiment shown in FIG. 7, the fan 21 comprises a horizontal fan resting perpendicular to the first and second panels 12, 13, similar to those used to cool computers. In some embodiments, the first and second cutouts 23, 24 are adapted to fit a variety of other heating and circulating elements, such as a hair dryer as shown in FIG. 6. All varieties of fan 21 are adapted to circulate air upwards to provide ventilation of the liner 22.

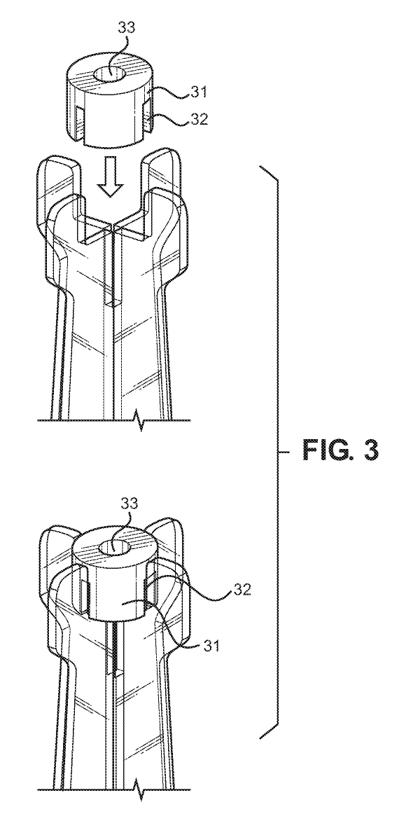

Referring now to FIG. 3, there is shown a perspective view of an embodiment of the cylindrical cap of the drying device being attached to the first and the second head and a perspective view of an embodiment of the cylindrical cap of the drying device attached to the first and the second head, respectively. A cap 31 having an aperture 33 is adapted to removably secure to the first and second heads 14, 15. In the illustrated embodiment, the cap 31 is cylindrical. In the illustrated embodiment, the cap 31 removably secures via one or more notches 32. The one or more notches 32 are adapted to fit the first and second panels 12, 13 therein. The cap 31 is configured to rest between the first and second plurality of protrusions, 18, 27. In some embodiments, the aperture 33 is threaded to receive a fastener.

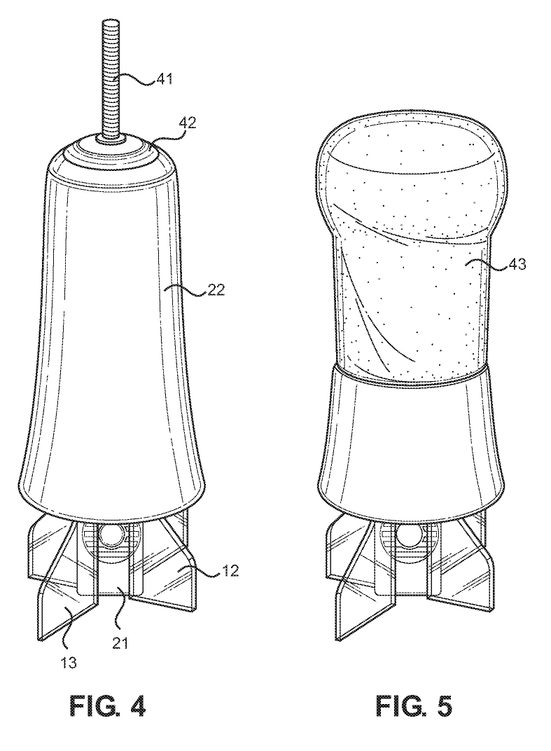

Referring now to FIG. 4, there is shown a perspective view of an embodiment of the drying device in use. In the illustrated embodiment, the liner 22 further comprises a cylindrical bolt 41 and a rounded plate 42. The cylindrical bolt 41 is configured to seat within the aperture 33 of the cap 31 to secure the liner 22 to the drying device 11. The fan 21 then ventilates the liner 22. In some embodiments, the cylindrical bolt 41 is threaded to engage with the aperture 33.

Referring now to FIG. 5, there is shown a perspective view of an embodiment of the drying device in use. In the illustrated embodiment, the liner 22 of FIG. 4 is inverted over the drying device 11. The inner lining 43 protects the user from abrasions from the cylindrical bolt 41 and rounded plate 42 assembly. The cylindrical bolt 41 is inserted into the aperture 33 of the cap 31. In some embodiments, the aperture 33 is threaded to engage with the cylindrical bolt 41.

In use, the first and second panels 12, 13 are interlocked perpendicularly by aligning the first and second mid-lines 25, 26 and lowering the second panel 13 over the first panel 12. Once perpendicularly interlocked, the cap 31 is lowered onto the first and second heads 14, 15 in order to removably secure the first and second panels 12, 13 together. The liner 22 is lowered over the first and second heads 14, 15 to rest on the first and second plurality of protrusions 18, 27. The fan 21 is placed under the liner 22 supported by the first and second panels 12, 13, such that the air circulated by the fan 21 moves upward to ventilate the liner 22. In some embodiments, a fastening device such as a cylindrical bolt 41 can be used to removably secure the liner 22 to the drying device 11.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A drying device, comprising:
a first panel comprising a first head and a first base, wherein a first plurality of protruding members extend from the first head about a first mid-line;
a second panel comprising a second head and a second base, wherein a second plurality of protruding members extend from the second head about a second mid-line;
wherein the first panel and the second panel are adapted to interlock perpendicularly with each other along the first and the second mid-lines, respectively, to form an X shape.

2) The drying device of claim 1, wherein the first panel includes a first slot extending downwards from the first head at the first mid-line and the second panel includes a second slot extending upwards from the second base at the second mid-line.

3) The drying device of claim 2, wherein the first slot and the second slot are adapted to perpendicularly interlock the first panel and the second panel.

4) The drying device of claim 1, wherein the first panel includes a first cutout and the second panel includes a second cutout, wherein the first cutout and the second cutout are adapted to fit a fan therein.

5) The drying device of claim 4, further comprising a fan.

6) The drying device of claim 5, wherein the fan comprises a vertical fan.

7) The drying device of claim 5, wherein the fan comprises a horizontal fan.

8) The drying device of claim 5, wherein the fan comprises a heating element.

9) The drying device of claim 4, wherein the first cutout is disposed on the first base and the second cutout is disposed on the second base.

10) The drying device of claim 1, wherein the first and the second plurality of protrusions comprise a rounded upper end.

11) The drying device of claim 1, further comprising a fan disposed within the first base.

12) The drying device of claim 1, further comprising a cap adapted to removably secure the first panel to the second panel at the first head and the second head via one or more notches.

13) The drying device of claim 6, wherein the cap further includes an aperture configured to receive a fastener.

14) The drying device of claim 1, further comprising a fastener disposed at the cap, wherein the fastener is adapted to removably secure a liner in a desired position.

15) The drying device of claim 8, wherein the fastener comprises a cylindrical bolt and a rounded plate, wherein the cylindrical bolt is adapted to engage with the aperture of the cap.

16) The drying device of claim 9, wherein the cylindrical bolt and the rounded plate are integral to the liner.

17) The drying device of claim 1, wherein the first and the second plurality of protrusions extend equiangularly from the first and the second head about the first and the second mid-line, respectively.
